(19) United States
(12) Patent Application Publication
(10) Pub. No.: US 2024/0302630 A1
(43) Pub. Date: Sep. 12, 2024

(54) IMAGE PICKUP LENS AND CAMERA MODULE

(71) Applicant: Sharp Sensing Technology Corporation, Tenri City (JP)

(72) Inventors: Yuhichi IESHIMA, Tenri City (JP); Kohji MOTOYAMA, Tenri City (JP); Yasuaki ISOBE, Tenri City (JP); Fumihiro NISHIO, Tenri City (JP); Shohnosuke UENO, Tenri City (JP)

(21) Appl. No.: 18/581,482

(22) Filed: Feb. 20, 2024

(30) Foreign Application Priority Data
Mar. 10, 2023 (JP) 2023-038072

(51) Int. Cl. G02B 13/00

(52) U.S. Cl. CPC G02B 13/0045

(57) ABSTRACT

The risk of deterioration in optical characteristic is reduced. An image pickup lens includes a second lens that has an abutting portion which is located on a rim of a lens surface and which abuts on a frame.

This Nonprovisional application claims priority under 35 U.S.C. § 119 on Patent Application No. 2023-038072 filed in Japan on Mar. 10, 2023, the entire contents of which are hereby incorporated by reference.

### TECHNICAL FIELD

The present disclosure relates to an image pickup lens and a camera module.

### BACKGROUND ART

Patent Literature 1 discloses a camera module that includes an upper lens group and a liquid lens which can abut on the upper lens group.

### CITATION LIST

### Patent Literature

### [Patent Literature 1]

Published Japanese Translation of PCT International Application Tokuhyo No. 2020-501194

### SUMMARY OF INVENTION

### Technical Problem

In the camera module disclosed in Patent Literature 1, there is a risk of deterioration in optical characteristic resulting from unintended tilting of the upper lens group with respect to the liquid lens.

### Solution to Problem

An image pickup lens in accordance with an aspect of the present disclosure includes: a first lens, the first lens having a lens body and a frame located around a perimeter of the lens body; and a second lens located at a position closer to an object than the first lens, the second lens having a lens surface and an abutting portion, the lens surface facing the lens body, the abutting portion being located on a rim of the lens surface and abutting on the frame.

### Advantageous Effects of Invention

According to an aspect of the present disclosure, it is possible to reduce the risk of deterioration in optical characteristic.

### BRIEF DESCRIPTION OF DRAWINGS

FIG. 1 is a cross-sectional view schematically illustrating configurations of a camera module and an image pickup lens in accordance with the present disclosure.

FIG. 2 is a side view illustrating an area in which an abutting portion abuts on a frame and its surroundings.

FIG. 3 is a bottom view of a second lens.

### DESCRIPTION OF EMBODIMENTS

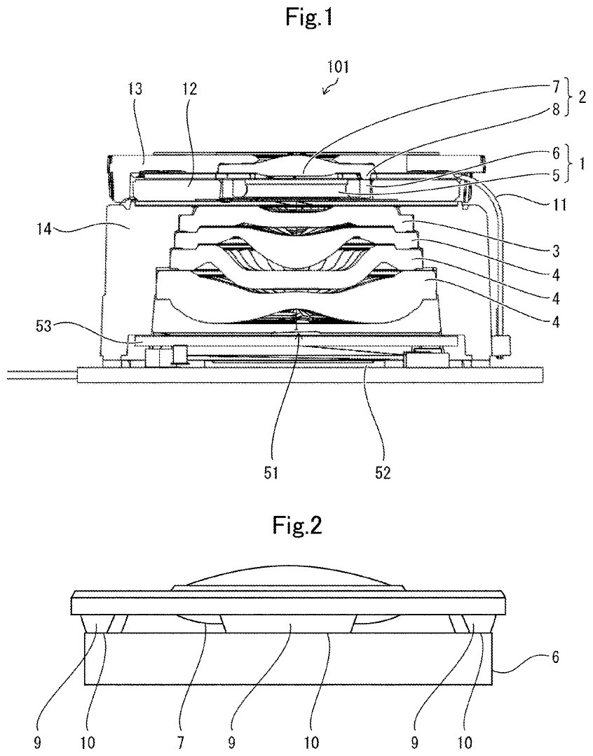

FIG. 1 is a cross-sectional view schematically illustrating configurations of a camera module 101 and an image pickup lens 51 in accordance with the present disclosure. The camera module 101 includes the image pickup lens 51 and an image pickup element 52 that receives light having passed through the image pickup lens 51.

The image pickup lens 51 includes a first lens 1, a second lens 2, and a third lens 3. The second lens 2 is located at a position closer to an object (a subject) than the first lens 1. The third lens 3 is located at a position closer to an image-forming plane (an image plane) than the first lens 1. The position closer to the image-forming plane in the image pickup lens 51 can be rephrased as a position closer to the image pickup element 52 in the camera module 101. The image pickup lens 51 may include one or more fourth lenses 4 that are located at a position closer to the image-forming plane than the third lens 3. In FIG. 1, the number of the fourth lenses 4 is three.

The first lens 1 has a lens body 5 and a frame 6 that is located around the perimeter of the lens body 5. The lens body 5 may have a polymer lens. Thus, it is possible to easily achieve an autofocus function using the first lens 1. The frame 6 may hold the lens body 5.

The second lens 2 has a lens surface 7 that faces the lens body 5 and an abutting portion 8 that is located on the rim of the lens surface 7 and that abuts on the frame 6.

According to the image pickup lens 51, the abutting portion 8 abuts on the frame 6, so that the second lens 2 is positioned with respect to the first lens 1. Thus, it is possible to reduce the risk of deterioration in optical characteristic resulting from unintended tilting of the second lens 2 with respect to the first lens 1. According to the image pickup lens 51, it is possible to reduce the risk of deterioration in optical characteristic with a simple configuration in which the abutting portion 8 is provided on the rim of the lens surface 7.

In the image pickup lens 51, the third lens 3 and the fourth lenses 4 are not essential components. However, the provision of the third lens 3 and/or the fourth lenses 4 enables achievement of a higher optical characteristic.

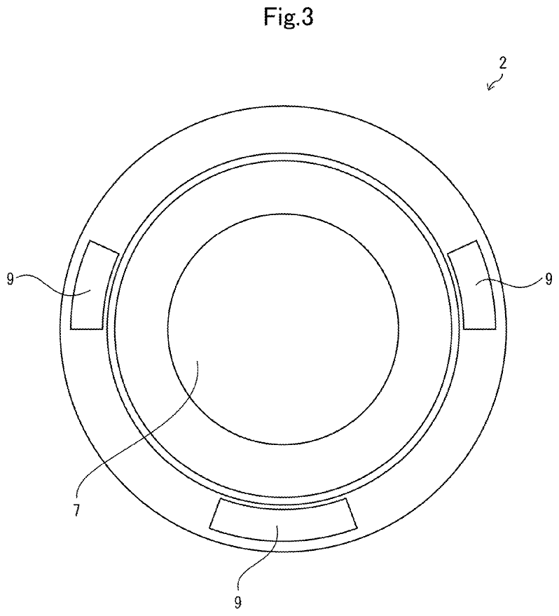

FIG. 2 is a side view illustrating an area in which the abutting portion 8 abuts on the frame 6 and its surroundings. FIG. 3 is a bottom view of the second lens 2.

The abutting portion 8 may be constituted by three or more protrusions 9. Each of the three or more protrusions 9 may protrude toward the frame 6. Thus, a total area of the abutting portion 8 in a plan view of the image pickup lens 51 is small. Therefore, in the event of the occurrence of a misalignment of the abutting portion 8 in the plan view of the image pickup lens 51, it is possible to reduce the risk of damage to the lens body 5 due to a collision of the abutting portion 8 with the lens body 5.

Tips 10 of the protrusions 9 may each be located at a position closer to the first lens 1 than the whole of the lens surface 7. Thus, it is possible to reduce the risk of damage to the lens surface 7 and/or the lens body 5 due to a collision of the lens surface 7 with the lens body 5.

The second lens 2, the third lens 3, and the fourth lenses 4 may each be a plastic lens. The abutting portion 8 is not limited to a form of three or more protrusions 9, and may be, for example, a form of an annular protrusion portion surrounding the lens surface 7.

The image pickup lens 51 may include a flexible substrate 11 under which the first lens 1 is provided and which is electrically connected to the first lens 1. The image pickup lens 51 may include a substrate holding member 12 that accommodates the first lens 1 and that holds the flexible substrate 11. The image pickup lens 51 may include a lens cover 13 that covers an outer region of an object-side surface of the second lens 2. The image pickup lens 51 may include a lens barrel 14 that accommodates the third lens 3 and the fourth lenses 4. The camera module 101 may include a cover glass 53 that covers the image pickup element 52.

Aspects of the present disclosure can also be expressed as follows:

An image pickup lens in accordance with a first aspect of the present disclosure includes: a first lens, the first lens having a lens body and a frame located around a perimeter of the lens body; and a second lens located at a position closer to an object than the first lens, the second lens having a lens surface and an abutting portion, the lens surface facing the lens body, the abutting portion being located on a rim of the lens surface and abutting on the frame.

According to the above-described configuration, the abutting portion abuts on the frame, so that the second lens is positioned with respect to the first lens. Thus, it is possible to reduce the risk of deterioration in optical characteristic resulting from unintended tilting of the second lens with respect to the first lens. It is possible to reduce the risk of deterioration in optical characteristic with a simple configuration in which the abutting portion is provided on the rim of the lens surface.

In a second aspect of the present disclosure, the image pickup lens is configured, in the first aspect of the present disclosure, such that the abutting portion is constituted by three or more protrusions, and the three or more protrusions each protrude toward the frame.

According to the above-described configuration, a total area of the abutting portion in a plan view is small. Therefore, in the event of the occurrence of a misalignment of the abutting portion in the plan view, it is possible to reduce the risk of damage to the lens body due to a collision of the abutting portion with the lens body.

In a third aspect of the present disclosure, the image pickup lens is configured, in the second aspect of the present disclosure, such that tips of the protrusions are each located at a position closer to the first lens than a whole of the lens surface.

According to the above-described configuration, it is possible to reduce the risk of damage to the lens surface and/or the lens body due to a collision of the lens surface with the lens body.

In a fourth aspect of the present disclosure, the image pickup lens is configured, in any of the first to third aspects of the present disclosure, such that the lens body has a polymer lens.

According to the above-described configuration, it is possible to easily achieve an autofocus function using the first lens.

In a fifth aspect of the present disclosure, the image pickup lens is configured, in any of the first to fourth aspects of the present disclosure, to include a third lens located at a position closer to an image-forming plane than the first lens.

According to the above-described configuration, it is possible to achieve a higher optical characteristic.

A camera module in accordance with a sixth aspect of the present disclosure includes: the image pickup lens; and an image pickup element that receives light having passed through the image pickup lens.

The present disclosure is not limited to the above-described embodiments, but can be altered by a skilled person in the art within the scope of the claims. The present disclosure also encompasses, in its technical scope of the present disclosure, any embodiment derived by combining technical means disclosed in differing embodiments. Further, a novel technical feature can be created by a combination of technical means disclosed in these embodiments.

### REFERENCE SIGNS LIST

1: first lens
2: second lens
3: third lens
4: fourth lens
5: lens body
6: frame
7: lens surface
8: abutting portion
9: protrusion
10: tip of protrusion
11: flexible substrate
12: substrate holding member
13: lens cover
14: lens barrel
51: image pickup lens
52: image pickup element
53: cover glass
101: camera module

1. An image pickup lens comprising:
a first lens, the first lens having a lens body and a frame located around a perimeter of the lens body; and
a second lens located at a position closer to an object than the first lens, the second lens having a lens surface and an abutting portion, the lens surface facing the lens body, the abutting portion being located on a rim of the lens surface and abutting on the frame.

2. The image pickup lens according to claim 1, wherein
the abutting portion is constituted by three or more protrusions, and
the three or more protrusions each protrude toward the frame.

3. The image pickup lens according to claim 2, wherein tips of the protrusions are each located at a position closer to the first lens than a whole of the lens surface.

4. The image pickup lens according to claim 1, wherein the lens body has a polymer lens.

5. The image pickup lens according to claim 1, comprising a third lens located at a position closer to an image-forming plane than the first lens.

6. A camera module comprising:
the image pickup lens according to claim 1; and
an image pickup element that receives light having passed through the image pickup lens.
